(19) United States
(12) Patent Application Publication
(10) Pub. No.: US 2016/0089950 A1
(43) Pub. Date: Mar. 31, 2016

(54) HYDRAULIC SHOCK ABSORBER

(71) Applicant: TOYOTA JIDOSHA KABUSHIKI KAISHA, Toyota-shi (JP)

(72) Inventor: Takenari YAMAGUCHI, Toyota-shi (JP)

(73) Assignee: TOYOTA JIDOSHA KABUSHIKI KAISHA, Toyota-shi (JP)

(21) Appl. No.: 14/778,434

(22) PCT Filed: Mar. 29, 2013
(86) PCT No.: PCT/JP2013/059510

§ 371 Date: Sep. 18, 2015

(51) Int. Cl. B60G 17/08; B60G 13/08

(52) U.S. Cl. CPC B60G 17/08; B60G 13/08

(57) ABSTRACT

A hydraulic shock absorber includes a damping force generator configured to, when a current is supplied, generate a current-dependent damping force as a damping force relating to a magnitude of the current supplied and configured to, when no current is supplied, generate a current-non-supply-state set damping force as a damping force with a preset magnitude. This hydraulic shock absorber is configured to inhibit a supply of the current to the damping force generator when the current to be supplied to the damping force generator is greater than a threshold value. When a current to be received by the damping force generator is to increase to a value larger than the threshold value, the supply of the current to the damping force generator is inhibited, and the current-non-supply-state set damping force is generated, making it possible to reliably achieve a damping capacity while reducing power consumption.

### TECHNICAL FIELD

The present invention relates to a hydraulic shock absorber mounted on a vehicle.

### BACKGROUND ART

Patent Document described below discloses a hydraulic shock absorber including (A) a cylinder including: a housing configured to store working fluid; a piston provided slidably in the housing; and a rod including one end portion coupled to the piston and another end portion protruding from the housing, the cylinder being provided so as to connect between a sprung portion and an unsprung portion of a vehicle, the cylinder being extended and compressed by relative movement between the sprung portion and the unsprung portion, and (B) a damping force generator configured to provide a resistance to a flow of the working fluid with at least one of extension and compression of the cylinder to generate a damping force for the at least one of the extension and the compression of the cylinder, the damping force generator being configured to, when a current is supplied to the damping force generator, generate a current-dependent damping force as a damping force having a magnitude related to a magnitude of the supplied current, the damping force generator being configured to, when no current is supplied to the damping force generator, generate a current-non-supply-state set damping force as a damping force having a preset magnitude.

Patent Document 1: Japanese Patent Application Publication No. 2011-132995

### SUMMARY OF THE INVENTION

### Object of the Invention

The above-described hydraulic shock absorber is still in a developing stage, and various improvement can increase the utility. The present invention has been developed in view of the above-described situations, and it is an object of the present invention to provide a hydraulic shock absorber having high utility.

### Means for Achieving Object

To achieve the above-described object, a hydraulic shock absorber according to the present invention includes: the above-described cylinder and damping force generator; and a controller configured to supply the current to the damping force generator and control a magnitude of the supplied current, and the controller is configured to, when the current to be supplied to the damping force generator is greater than a threshold value, inhibit a supply of the current to the damping force generator.

### Effect of the Invention

The hydraulic shock absorber according to the present invention is configured to, when a current received by the damping force generator increases to a value larger than the threshold value, for example, inhibit the supply of the current to the damping force generator to generate a current-non-supply-state set damping force. That is, the hydraulic shock absorber according to the present invention can reliably achieve a damping capacity while reducing power consumption, resulting in high utility of the hydraulic shock absorber according to the present invention.

### Forms of the Invention

There will be described various forms of invention which is considered claimable (hereinafter referred to as “claimable invention” where appropriate). Each of these forms of the invention is numbered like the appended claims and depends from the other form or forms, where appropriate. This is for easier understanding of the claimable invention, and it is to be understood that combinations of constituent elements that constitute the invention are not limited to those described in the following forms. That is, it is to be understood that the claimable invention shall be construed in the light of the following descriptions of the various forms and preferred embodiments. It is to be further understood that any form in which one or more elements is/are added to or deleted from any one of the following forms may be considered as one form of the claimable invention.

It is noted that the following forms (1)-(8) respectively correspond to claims 1-8.

(1) A hydraulic shock absorber, comprising:

a cylinder comprising: a housing configured to store working fluid; a piston provided slidably in the housing; and a rod comprising one end portion coupled to the piston and another end portion protruding from the housing, the cylinder being provided so as to connect between a sprung portion and an unsprung portion of a vehicle, the cylinder being extended and compressed by relative movement between the sprung portion and the unsprung portion;

a damping force generator configured to provide a resistance to a flow of the working fluid with at least one of extension and compression of the cylinder to generate a damping force for the at least one of the extension and the compression of the cylinder, the damping force generator being configured to, when a current is supplied to the damping force generator, generate a current-dependent damping force as a damping force having a magnitude related to a magnitude of the supplied current, the damping force generator being configured to, when no current is supplied to the damping force generator, generate a current-non-supply-state set damping force as a damping force having a preset magnitude; and

a controller configured to supply the current to the damping force generator and control a magnitude of the supplied current,

the controller being configured to, when the current to be supplied to the damping force generator is greater than a threshold value, inhibit a supply of the current to the damping force generator.

The hydraulic shock absorber according to this form is assumed to be configured to, when the damping force generator is receiving a current, generate the damping force related to the current and configured to, when no current is supplied to the damping force generator, generate a damping force having a particular magnitude. The damping force generator in this form may be configured to generate a damping force for both of the expression and the compression of the cylinder and may be configured to generate a damping force for any one of the expression and the compression of the cylinder. That is, the hydraulic shock absorber according to this form may include a single damping force generator configured to generate the damping force for both of the expression and the compression of the cylinder and may include two damping force generators configured to generate damping forces respectively for the extension and the compression of the cylinder.

The hydraulic shock absorber according to this form is configured to, when a current received by the damping force generator increases, for example, inhibit the supply of the current to the damping force generator to generate the current-non-supply-state set damping force. That is, the hydraulic shock absorber according to this form can reduce power consumption of the damping force generator. Also, the hydraulic shock absorber according to this form is configured such that, even when the supply of the current to the damping force generator is inhibited, the damping force generator generates the current-non-supply-state set damping force as a generally fixed damping force, thereby reliably achieving a damping capacity. It is noted that the threshold value in this form may be a generally fixed value and may be a value that is changeable based on a certain parameter, for example.

The damping force F_{D} generated by the above-described shock absorber depends upon a relative velocity v_{S/US} between the sprung portion and the unsprung portion (hereinafter may be referred to as “sprung-unsprung relative velocity”) and can be simply expressed in the following equation:

F_{D}=ζv_{S/US}(ζ: damping coefficient)

Thus, the same sprung-unsprung relative velocity v_{S/US} is a precondition in the case where damping forces of the damping force generator are compared with each other, for example. Accordingly, a variation of the damping force in the present specification may mean a difference in damping-force generation characteristics, specifically, a variation of the damping coefficient, and a change in the damping force may mean a change in the damping-force generation characteristics, specifically, a change in the damping coefficient.

According to the concept of the damping force, the current-dependent damping force generated by the damping force generator in the present form means a damping force whose damping-force generation characteristics change in accordance with a magnitude of the current supplied, i.e., a damping force based on a damping coefficient whose magnitude changes in accordance with a magnitude of the current supplied. Also, the current-non-supply-state set damping force means a damping force with fixed damping-force generation characteristics, i.e., a damping force based on a generally fixed damping coefficient.

In the hydraulic shock absorber according to this form, a method in which the controller determines the magnitude of the current to be supplied to the damping force generator is not limited in particular. Examples of the method include: a method of changing the supply current to change the damping coefficient in accordance with, e.g., a vehicle speed; and a method of determining a target damping force and supplying a current related to the target damping force.

(2) The hydraulic shock absorber according to the above form (1), wherein the damping force generator is configured such that the current-dependent damping force generated by the damping force generator increases with increase in current supplied to the damping force generator.

In the hydraulic shock absorber according to this form, a relationship between the current to be supplied to the damping force generator and the damping force to be generated by the damping force generator is specified.

(3) The hydraulic shock absorber according to the above form (2), wherein the hydraulic shock absorber is configured such that a magnitude of the current-non-supply-state set damping force is less than an upper limit value of the current-dependent damping force.

In this shock absorber, even when the damping force generator is to generate the current-non-supply-state set damping force as a damping force with a preset magnitude, a damping force to be actually generated by the damping force generator may vary with respect to the current-non-supply-state set damping force, for example, the damping force to be actually generated may be larger or smaller than the current-non-supply-state set damping force. In the shock absorber in this form, the current-non-supply-state set damping force is set to be smaller than the upper limit value of the current-dependent damping force. Accordingly, a damping force to be actually generated by the damping force generator when no current is supplied to the damping force generator can be made so as not to exceed the upper limit value of the current-dependent damping force, that is, the damping force generator can be inhibited from generating a damping force larger than necessary. It is noted that the upper limit value of the current-dependent damping force in this form may be a limit value that can be generated by the damping force generator having received the supplied current and may be a damping force corresponding to a limit value of current supplied in control in normal situations.

(4) The hydraulic shock absorber according to the above form (2) or (3),

wherein the hydraulic shock absorber is configured such that when no current is supplied to the damping force generator, there are variations in the damping force to be actually generated by the damping force generator, and

wherein a magnitude of the current-non-supply-state set damping force is set such that a maximum value of a range of possible variation of the damping force when no current is supplied to the damping force generator is equal to an upper limit value of the current-dependent damping force.

The hydraulic shock absorber according to this form sets the current-non-supply-state set damping force in consideration of variations of the damping force to be generated by the damping force generator. In the hydraulic shock absorber according to this form, a damping force within a range of damping force which may be actually generated by the damping force generator with respect to the current-non-supply-state set damping force is within a range of the current-dependent damping force. That is, in the shock absorber according to this form, when no current is supplied to the damping force generator, the damping force generator does not generate a larger damping force than necessary. Accordingly, even when no current is supplied to the damping force generator, effective vibration damping can be performed.

(5) The hydraulic shock absorber according to any one of the above forms (1) through (4), wherein the controller comprises an electrical-system-state-dependent current supply inhibiting device configured to determine the threshold value based on a state of an electrical system relating to the hydraulic shock absorber and to, when the current to be supplied to the damping force generator is greater than the determined threshold value, inhibit the supply of the current to the damping force generator.

In the hydraulic shock absorber according to this form, a limitation relating to the threshold value for inhibiting the current supply is added. The state of the electrical system relating to the hydraulic shock absorber in this form means a state in a circuit including the damping force generator, the controller, and a power source and connecting between the damping force generator and the power source. Examples of this state include: a degree of heat generated by the damping force generator, the controller, the power source, and so on; and a charging state of the power source. In the case where the current to be supplied to the damping force generator needs to be limited, for example, based on the state of the electrical system, the hydraulic shock absorber according to this form not only limits the magnitude of the supply current but also inhibits the supply of the current, enabling effective reduction in power consumption.

(6) The hydraulic shock absorber according to the above form (5), wherein the electrical-system-state-dependent current supply inhibiting device uses a temperature of the controller as the state of the electrical system relating to the hydraulic shock absorber.

In the hydraulic shock absorber according to this form, a limitation is added to the state of the electrical system. In the case where the temperature of the controller is high, it is possible to consider that heavy loads are imposed on the controller and the damping force generator. In the hydraulic shock absorber according to this form, the supply of the current can be inhibited in such a case, enabling reduction in loads of the controller and the damping force. It is noted that the temperature of the controller may be directly measured and may be indirectly estimated based on another or other parameters.

(7) The hydraulic shock absorber according to any one of the above forms (1) through (6), wherein the hydraulic shock absorber is configured such that when no current is supplied to the damping force generator, there are variations in the damping force to be actually generated by the damping force generator,

wherein the damping force generator is configured such that the current-dependent damping force generated by the damping force generator increases with increase in current supplied to the damping force generator, and

wherein the controller includes a minimum-set-damping-force-dependent current supply inhibiting device configured to: use, as the threshold value, a minimum-set-damping-force-corresponding current value which is a value of the current having a magnitude which is to generate, as the current-dependent damping force, the damping force having a magnitude equal to a minimum value of a range of possible variation of the damping force when no current is supplied to the damping force generator; and inhibit the supply of the current to the damping force generator when the current to be supplied to the damping force generator is greater than the minimum-set-damping-force-corresponding current value.

In the hydraulic shock absorber according to this form, a limitation relating to the threshold value for inhibiting the current supply is added. The hydraulic shock absorber according to this form is, in plain words, configured such that a damping force in a range in which the current-non-supply-state set damping force may be actually generated by the damping force generator is assured by a damping force generated by the damping force generator in a state in which no current is supplied to the damping force generator. The hydraulic shock absorber according to this form can effectively reduce power consumption while reducing an amount of lowering of the damping capacity.

It is noted that the minimum-set-damping-force-dependent current supply inhibiting device in this form is not limited to one configured to always inhibit the supply of the current to the damping force generator when the current to be supplied to the damping force generator is greater than the minimum-set-damping-force-corresponding current value. For example, the minimum-set-damping-force-dependent current supply inhibiting device may be configured to inhibit the supply of the current to the damping force generator when a set condition is satisfied and the current to be supplied to the damping force generator is greater than the minimum-set-damping-force-corresponding current value.

(8) The hydraulic shock absorber according to any one of the above forms (1) through (7),

wherein the damping force generator comprises: a main fluid passage through which the working fluid passes when the current is supplied to the damping force generator; and an auxiliary fluid passage through which the working fluid passes when no current is supplied to the damping force generator, and

wherein the damping force generator configured to; change the resistance to the flow of the working fluid passing through the main fluid passage in accordance with a magnitude of the current supplied to the damping force generator, to generate the current-dependent damping force having the magnitude related to the magnitude of the current; and provide the resistance to the flow of the working fluid passing through the auxiliary fluid passage, to generate the current-non-supply-state set damping force.

In the hydraulic shock absorber according to this form, a limitation relating to the structure of the damping force generator is added. In the damping force generator according to this form, the resistance is provided to the flow of the working fluid passing through the main fluid passage in accordance with the supplied current, enabling easy control of the current-dependent damping force. Further, the resistance is provided to the flow of the working fluid passing through the auxiliary fluid passage, enabling easy and reliable generation of the current-non-supply-state damping force in the case where the supply of the current is inhibited as described above or in the event of electrical failure, for example.

### BRIEF DESCRIPTION OF THE DRAWINGS

FIG. 1 is a schematic view illustrating a hydraulic shock absorber according to an embodiment of the claimable invention.

FIG. 2 is a cross-sectional view illustrating a damping force generator of the hydraulic shock absorber illustrated in FIG. 1.

FIG. 3 is a view illustrating a magnetic path of a solenoid of the damping force generator illustrated in FIG. 2.

FIG. 4 is a graph schematically illustrating a relationship between a current supplied to the damping force generator and a damping force generated by the damping force generator.

FIG. 5 is a graph schematically illustrating a relationship between a sprung-unsprung relative velocity and the damping force generated by the damping force generator.

FIG. 6 is a flow chart illustrating an absorber control program executed by a controller of the hydraulic shock absorber in FIG. 1.

FIG. 7 is a block diagram illustrating functions of the controller in FIG. 1.

### EMBODIMENT FOR IMPLEMENTING INVENTION

Hereinafter, there will be described an embodiment of the claimable invention as a form for implementing the claimable invention by reference to the drawings. It is to be understood that the claimable invention is not limited to the details of the following embodiment but may be embodied with various changes and modifications, such as those described in the FORMS OF THE INVENTION, which may occur to those skilled in the art. Further, modifications of the embodiment described later may be achieved using the technical features described in the explanation in each form of the FORMS OF THE INVENTION.

### EMBODIMENT

### [A] Overall Configuration of Hydraulic Shock Absorber

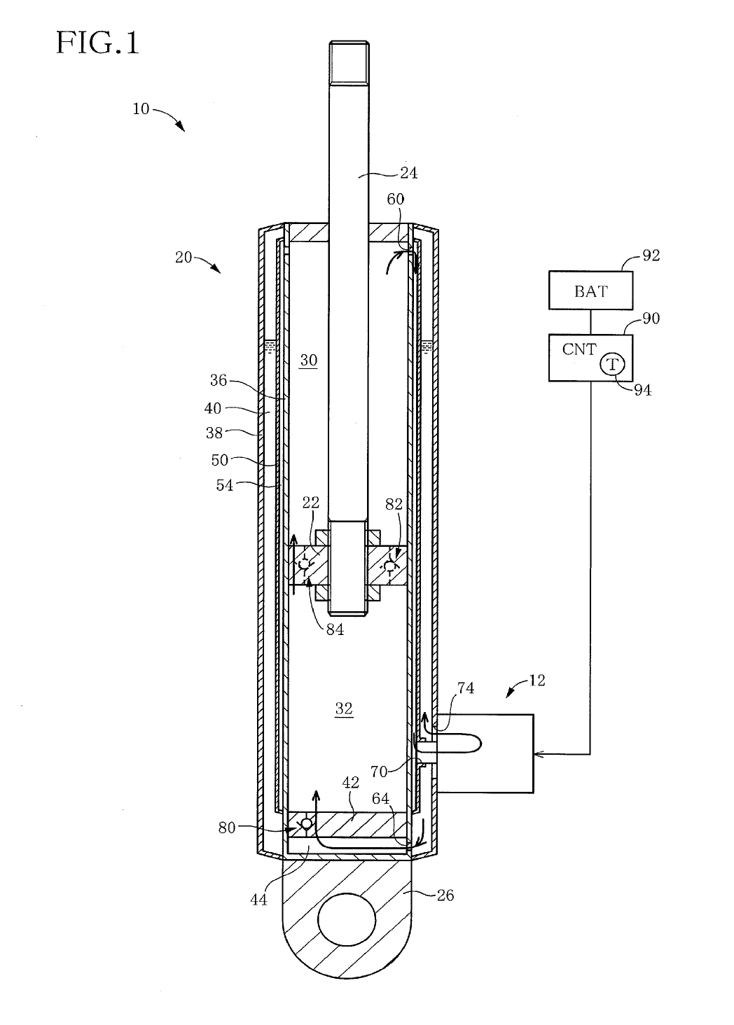

As illustrated in FIG. 1, a hydraulic shock absorber (hereinafter may be simply referred to as “absorber”) according to an embodiment of the claimable invention includes a cylinder 10 and a damping force generator 12 as main components.

The cylinder 10 includes: a housing 20; a piston 22 disposed in the housing 20 so as to be movable in the up and down direction in the housing 20; and a rod 24 having one end portion (i.e., a lower end portion) coupled to the piston 22 and the other end portion (i.e., an upper end portion) extending upward from the housing 20. A lower end of the housing 20 is provided with a coupling member 26. The housing 20 is coupled to an unsprung portion of a vehicle (e.g., a suspension lower arm and a steering knuckle) via the coupling member 26. An upper end portion of the rod 24 has a male thread which is used for coupling the rod 24 to a sprung portion of the vehicle (e.g., a mount provided on a vehicle body). That is, the cylinder 10 is disposed so as to connect between the sprung portion and the unsprung portion of the vehicle. The cylinder 10 is extended and compressed with relative movement of the sprung portion and the unsprung portion in the up and down direction, e.g., movement of the sprung portion and the unsprung portion toward and away from each other. Specifically, the cylinder 10 is extended when the sprung portion and the unsprung portion are moved relative to each other in a direction away from each other (hereinafter this movement may be referred to as “in rebound motion” or “in rebounding”), and the cylinder 10 is compressed when the sprung portion and the unsprung portion are moved relative to each other in a direction toward each other (hereinafter this movement may be referred to as “in bound motion” or “in bounding”).

The piston 22 is kept in contact with and slidable in the housing 20. The interior of the housing 20 is partitioned by the piston 22 into two fluid chambers 30, 32 each filled with working fluid. Specifically, the interior of the housing 20 is partitioned into the rod-side chamber 30 located over the piston 22 and the opposite-rod-side chamber 32 located under the piston 22, and the rod 24 extends through the rod-side chamber 30. The volume of each of the two fluid chambers 30, 32 changes with extension and compression of the cylinder 10, i.e., relative movement between the sprung portion and the unsprung portion. Specifically, in the rebound motion, the volume of the rod-side chamber 30 decreases, and the volume of the opposite-rod-side chamber 32 increases. In the bound motion, on the other hand, the volume of the rod-side chamber 30 increases, and the volume of the opposite-rod-side chamber 32 decreases.

The housing 20 has generally a two-ply structure and includes: a main tube 36 having a closed bottom; and an outer tube 38 provided on an outer circumferential side of the main tube 36. An inner circumferential surface of the main tube 36 defines circumferential sides of the rod-side chamber 30 and the opposite-rod-side chamber 32. A buffer chamber 40 for storing the working fluid is defined between an outer circumferential surface of the main tube 36 and an inner circumferential surface of the outer tube 38. This buffer chamber 40 may also be referred to as “reservoir” or “reservoir chamber”. The total volume of the rod-side chamber 30 and the opposite-rod-side chamber 32 increases in rebounding and decreases in bounding due to the rod 24. The buffer chamber 40 is a fluid chamber provided for allowing changes in the total volume in a state in which the rod-side chamber 30 and the opposite-rod-side chamber 32 are filled with the working fluid. It is noted that a partition 42 is provided in an inner bottom portion of the main tube 36 to define the bottom of the opposite-rod-side chamber 32. A bottom fluid passage 44 is formed between the partition 42 and a bottom wall of the main tube 36.

An intertube 50 is provided between the main tube 36 and the outer tube 38 such that the main tube 36 is surrounded with this intertube 50. Specifically, an inner circumferential side of the buffer chamber 40 is partly defined by an outer circumferential surface of the intertube 50. A relatively long annular fluid passage 54 is defined between an inner circumferential surface of the intertube 50 and the outer circumferential surface of the main tube 36.

An upper portion of the main tube 36 has a communication hole 60 for communication of the working fluid between the fluid passage 54 and the rod-side chamber 30. A portion of the main tube 36 near its lower end has a bottom communication hole 64 for communication of the working fluid between the buffer chamber 40 and the bottom fluid passage 44. A lower portion of the intertube 50 has an outlet opening 70 which allows a flow of the working fluid from the fluid passage 54 to the damping force generator 12. The outer tube 38 has an inlet opening 74 which is coaxial with the outlet opening 70 and which allows a flow of the working fluid from the damping force generator 12 into the buffer chamber 40. It is noted that this flow will be explained later in detail.

The partition 42 includes: a fluid passage connecting between the bottom fluid passage 44 and the opposite-rod-side chamber; and an opposite-rod-side-chamber check valve 80 provided in the fluid passage. The opposite-rod-side-chamber check valve 80 is a check valve having functions for allowing a flow of the working fluid from the buffer chamber 40 into the opposite-rod-side chamber 32 via the bottom fluid passage 44 with little resistance and inhibiting a flow of the working fluid from the opposite-rod-side chamber 32 into the buffer chamber 40 via the bottom fluid passage 44.

The piston 22 includes: a pair of fluid passages connecting between the rod-side chamber 30 and the opposite-rod-side chamber 32; and a pair of check valves 82, 84 provided respectively in the pair of fluid passages. The check valve 82 has functions for allowing a passage of the working fluid from the rod-side chamber 30 into the opposite-rod-side chamber 32 and inhibiting a passage of the working fluid from the opposite-rod-side chamber 32 into the rod-side chamber 30. The check valve 84 has functions for allowing a passage of the working fluid from the opposite-rod-side chamber 32 into the rod-side chamber 30 and inhibiting a passage of the working fluid from the rod-side chamber 30 into the opposite-rod-side chamber 32. However, the check valve 82 allows the passage of the working fluid only in a situation in which the pressure of the working fluid in the rod-side chamber 30 is considerably higher than that of the working fluid in the opposite-rod-side chamber 32. This construction substantially inhibits the working fluid from passing through the piston 22 from the rod-side chamber 30 into the opposite-rod-side chamber 32 in normal situations.

As explained later in detail, the damping force generator 12 is disposed so as to cover the outlet opening 70 and the inlet opening 74 and constructed to have a function for allowing a passage of the working fluid from the rod-side chamber 30 into the buffer chamber 40 via the fluid passage 54 while providing a resistance to the flow of the working fluid.

In the absorber according to the embodiment constructed as described above, in the bound motion, as indicated by the solid line arrow in FIG. 1, the working fluid first flows from the opposite-rod-side chamber 32 into the rod-side chamber 30 of the cylinder 10 via the fluid passage at which the check valve 84 of the piston 22 is disposed. An amount of the working fluid flowing into the rod-side chamber 30 is larger than an amount of increase in volume of the rod-side chamber 30 with the motion of the piston 22. Thus, the working fluid flows from the rod-side chamber 30 into the buffer chamber 40 via the communication hole 60 and the fluid passage 54 and through the damping force generator 12. A resistance provided to the flow of the working fluid passing through the damping force generator 12 generates a damping force for the compression of the cylinder 10, i.e., a damping force for the bound motion.

In the rebound motion, as in the bound motion, the working fluid flows from the rod-side chamber 30 of the cylinder 10 into the buffer chamber 40 via the communication hole 60 and the fluid passage 54 and through the damping force generator 12. A resistance provided to the flow of the working fluid passing through the clamping force generator 12 generates a damping force for the extension of the cylinder 10, i.e., a damping force for the rebound motion. As indicated by the broken line arrow in FIG. 1, the working fluid flows from the buffer chamber 40 into the opposite-rod-side chamber 32 of the cylinder 10 via the bottom communication hole 64, the bottom fluid passage 44, and the opposite-rod-side-chamber check valve 80. It is noted that the magnitude of each of the damping forces for the bound motion and the rebound motion depends on the resistance provided to the working fluid by the damping force generator 12. The damping force increases with increase in the resistance.

As explained later in detail, the damping force generator 12 is an electromagnetic valve, and the magnitude of the resistance provided by the damping force generator 12 depends on the magnitude of a supplied current. That is, each of the damping forces for the rebound motion and the bound motion depends on the magnitude of the supplied current. The damping force generator 12 is connected to a battery 92 (indicated by “BAT” in FIG. 1) as a power source via a controller 90 (indicated by “CNT” in FIG. 1). The controller 90 controls the current supplied to the damping force generator 12. The controller 90 is provided with a thermometer 94 for measuring a temperature T of the controller 90. The battery 92 recognizes a charged amount thereof, specifically, a remaining power amount Q thereof and transmits the remaining power amount Q to the controller 90.

### [B] Damping Force Generator

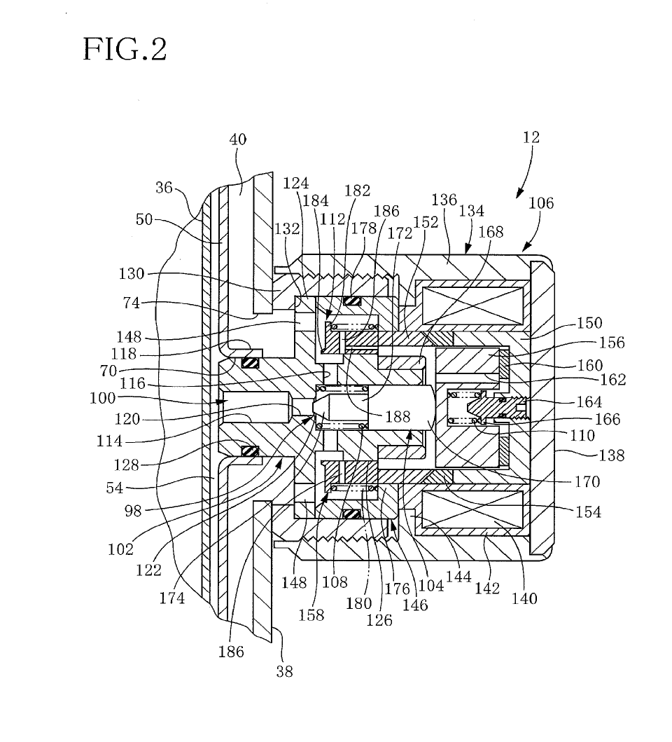

There will be next explained a structure and operations of the damping force generator 12 with reference to FIG. 2. The damping force generator 12 includes a valve mechanism 98, as a main component, for providing a resistance to the working fluid passing thorough the valve mechanism 98. Specifically, the damping force generator 12 includes: a hollow valve housing 102 having a fluid passage 100 through which the working fluid flows; a valve member (which may be also referred to as “valve movable member”) 104 provided in the valve housing 102; a solenoid 106; a spring 108 as a compression coil spring; and a spring 110 as a compression coil spring. The solenoid 106 has a function for applying an urging force to the valve member 104 constituting the valve mechanism 98 in a direction in which a fluid passage area is limited. The spring 108 has a function for applying an urging force to the valve member 104 in a direction in which the fluid passage area is made largest. The spring 110 has a function for applying an urging force to the valve member 104 in the direction in which the fluid passage area is limited. The damping force generator 12 further includes a fail-safe valve 112 disposed in the middle of the fluid passage 100 in series with the valve mechanism 98.

The valve housing 102 has: a lateral hole 114 extending along the axis of the damping force generator 12; and a vertical hole 116 communicating with the lateral hole 114. An outer circumferential surface of a distal end (a left end in FIG. 2) of the valve housing 102 is fitted in a sleeve 118 provided at the outlet opening 70 of the intertube 50. As a result, an opening portion of a left end of the lateral hole 114 faces the inside of the fluid passage 54 formed between the main tube 36 and the intertube 50, and the vertical hole 116 faces the buffer chamber 40. The fluid passage 100 is constituted by the lateral hole 114 and the vertical hole 116.

The valve housing 102 includes a small inside diameter portion 120 in the middle of the lateral hole 114, specifically, on one of opposite sides of the vertical hole 116 nearer to the fluid passage 54 (on a left side in FIG. 2). An inner edge of the small inside diameter portion 120 forms an annular valve seat 122. The valve housing 102 at its outer circumferential portion includes: a flange 124 located one of opposite sides of an opening portion of the vertical hole 116 nearer to the fluid passage 54; and a large outside diameter portion 126 located on the other of the opposite sides of the opening portion of the vertical hole 116 (on a right side in FIG. 2).

A seal ring 128 is mounted on an outer circumferential surface of a portion of the valve housing 102 at which the valve housing 102 is fitted in the sleeve 118. This seal ring seals off a position between the fluid passage 54 and the buffer chamber 40 to prevent communication between the fluid passage 54 and the buffer chamber 40 via passages other than the fluid passage 100.

The flange 124 of the valve housing 102 is fitted in an inner circumferential surface of a pipe 130 mounted in the inlet opening 74 of the outer tube 38 and is in contact with a step 132 provided on the inner circumferential surface of the pipe 130. The pipe 130 has a threaded portion, not shown, on an outer circumferential surface of an end portion of the pipe 130. A casing 134 shaped like a cylinder having a closed bottom and containing the solenoid 106 is engaged with the pipe 130 via the threaded portion.

The casing 134 includes: a pipe portion 136; a bottom portion 138 fixed to the pipe portion 136 by screwing an open end of the bottom portion 138; and an inner flange 144 provided on an inner circumferential side of the pipe portion 136 and holding a solenoid bobbin 142 that holds a coil 140 of the solenoid 106. The flange 124 of the valve housing 102 and a spacer 146 formed of non-magnetic material are sandwiched between the inner flange 144 and the step 132 provided on the pipe 130, whereby the valve housing 102 is fixed to the cylinder 10. The flange 124 has a through hole 148 for preventing the flange 124 from isolating the fluid passage 100 from the buffer chamber 40 even in the construction in which the valve housing 102 is fixed to the cylinder 10.

The solenoid 106 includes: the casing 134 shaped like the cylinder having the closed bottom; the annular solenoid bobbin 142 holding the coil 140 and fixed to a bottom portion of the casing 134; a first fixed iron core 150 shaped like a cylinder having a closed bottom and fitted in an inner circumferential surface of the solenoid bobbin 142; and a cylindrical second fixed iron core 152 fitted similarly in the inner circumferential surface of the solenoid bobbin 142; a cylindrical spacer 154 formed of non-magnetic material, fitted similarly in the inner circumferential surface of the solenoid bobbin 142, and interposed between the first fixed iron core 150 and the second fixed iron core 152; a movable iron core 156 disposed on an inner circumferential side of the first fixed iron core 150 and shaped like a cylinder having a closed bottom; and a cylindrical fail-safe member (which may also be referred to as “fail-safe valve movable member”) 158 slidably mounted on an outer circumferential surface of the large outside diameter portion 126 of the valve housing 102 and functioning also as another movable iron core different from the movable iron core 156.

The movable iron core 156 shaped like the cylinder having the closed bottom is inserted into the first fixed iron core 150 such that an open end of the cylinder inserted first and that the movable iron core 156 is slidable on an inner circumferential surface of the first fixed iron core 150. The movable iron core 156 is disposed such that, even when the movable iron core 156 is inserted into the first fixed iron core 150 to a position at which the movable iron core 156 is brought into contact with a washer 160 formed of non-magnetic material and disposed on a bottom portion of the first fixed iron core 150, a side surface of a bottom portion of the movable iron core 156 (i.e., a left surface in FIG. 2) slightly faces or is located considerably close to an inner circumferential surface of the second fixed iron core 152. A circumferential wall of the cylinder of the movable iron core 156 has a communication hole 162 which prevents a space defined by the first fixed iron core 150 and the movable iron core 156 from being sealed off.

The spring 110 is provided between the movable iron core 156 and the first fixed iron core 150 to apply an urging force to the movable iron core 156 in a direction in which the movable iron core 156 is moved away from the first fixed iron core 150. The spring 110 is supported at its right end in FIG. 2 by a spring receiver 166 provided on a distal end of a spring-force adjusting screw 164 which is engaged with an axial central portion of the first fixed iron core 150. A position at which the spring 110 is supported can be changed in the right and left direction in FIG. 2 by advancing and retracting the spring-force adjusting screw 164 with respect to the first fixed iron core 150.

The cylindrical second fixed iron core 152 has an open end portion near the first fixed iron core 150. This open end portion is tapered such that its outer circumferential side is inclined. Magnetic flux generated during energizing of the coil 140 is concentrated on an inner circumferential side of a right end of the second fixed iron core 152. A left end (in FIG. 2) of the spacer 154 formed of non-magnetic material and interposed between the second fixed iron core 152 and the first fixed iron core 150 is shaped such that the left end matches the tapered portion of the second fixed iron core 152 in shape.

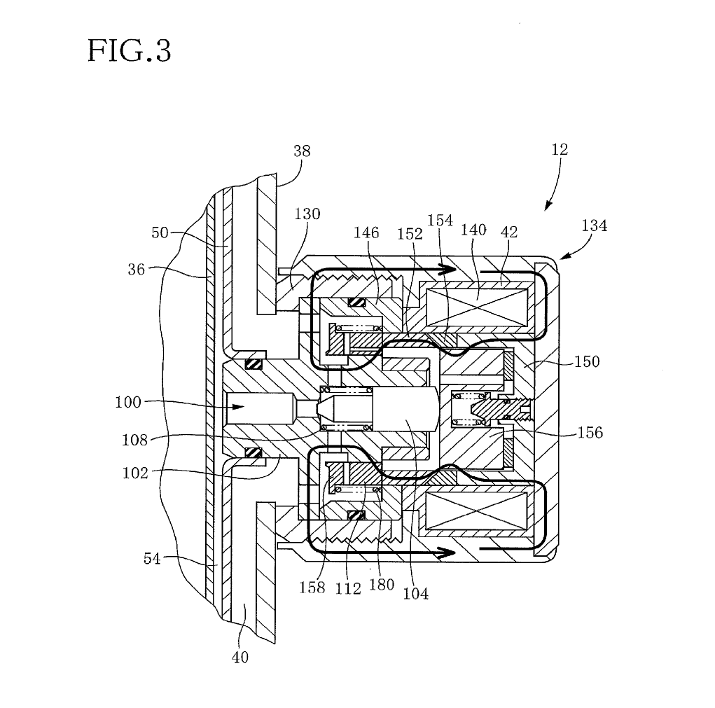

With these structures, a magnetic path indicated by the arrows in FIG. 3 is formed in the solenoid 106. Specifically, this magnetic path extends through the first fixed iron core 150, the movable iron core 156, and the second fixed iron core 152. When the coil 140 is energized to excite the solenoid 106, that is, when a current is supplied to the damping force generator 12, the movable iron core 156 located nearer to the first fixed iron core 150 is pulled toward the second fixed iron core 152, so that the movable iron core 156 receives an urging force in the left direction in FIG. 2.

As illustrated in FIG. 2, the bottom portion of the movable iron core 156 is held in contact with the valve member 104 constituting the valve mechanism 98, allowing an urging force of the spring 110 to be transferred to the valve member 104. During excitation of the solenoid 106, the urging force in the left direction in FIG. 2 is applied to the valve member 104 via the pulled movable iron core 156. It is noted that movement of the movable iron core 156 toward the valve member 104 (in the left direction in the figure) is limited by a cylindrical stopper 168 which is formed of non-magnetic material, fitted on an outer circumferential surface of a right end of the valve housing 102, and prevented by the large outside diameter portion 126 from moving in the left direction. That is, the limit of the movement is defined.

In the present damping force generator 12, the valve member 104 includes: a large diameter portion 170 held in slidable contact with an inner circumferential surface of the right end of the valve housing 102 in FIG. 2; a small diameter portion 172 extending from a left end of the large diameter portion 170 so as to face the vertical hole 116 of the valve housing 102; and a poppet valve head 174 formed on a left end of the small diameter portion 172. The valve head 174 is seated on and off the valve seat 122 to close and open the fluid passage 100. It is noted that this valve member 104 is configured such that a space is formed between an outer circumferential surface of the small diameter portion 172 and an inner circumferential surface of the valve housing 102 to prevent the valve member 104 from closing the vertical hole 116.

Also, the spring 108 is provided between the left end of the large diameter portion 170 of the valve member 104 and a right end of the small inside diameter portion 120 of the valve housing 102. This spring 108 applies an urging force to the valve member 104 in a direction in which the valve member 104 is moved away from the valve seat 122. That is, the spring 108 applies an urging force to the valve member 104 in a direction in which the fluid passage area of the fluid passage 100 is increased.

As a result, the valve member 104 is sandwiched between the spring 108 and the spring 110 via the movable iron core 156, so that the valve member 104 receives the urging force from the spring 108 in the direction in which the fluid passage area of the fluid passage 100 is increased, and receives the urging force from the spring 110 via the movable iron core 156 in the direction in which the fluid passage area is limited. In a state in which the coil 140 is not energized, the urging force applied to the valve member 104 from the spring 108 as an elastic member is equal to or larger than the urging force applied to the valve member 104 from the spring 110 as a shut-off elastic member, so that the movable iron core 156 is pushed into the first fixed iron core 150 until the movable iron core 156 is brought into contact with the washer 160. As a result, the valve member 104 is retracted from the valve seat 122 to a position at which the fluid passage 100 is opened in its maximum degree.

Here, since the spring 108 and the spring 110 are arranged in series as described above, adjusting the support position of the spring 110 with the spring-force adjusting screw 164 can not only change a length of the spring 110 in its compressed state, i.e., a compressed length of the spring 110 but also adjust a compressed length of the spring 108. This construction enables adjustment of the urging forces applied from these springs 108, 110 to the valve member 104, in particular, a normal urging force which is an urging force in a state in which no current is supplied to the solenoid 106. Accordingly, the adjustment of the normal urging force can adjust a position of the valve member 104 with respect to an amount of current supplied to the solenoid 106 (which can be considered to be an amount of current supplied to the damping force generator 12). That is, the adjustment of the normal urging force can adjust the fluid passage area in the valve mechanism 98.

Returning to the construction, the second fixed iron core 152 of the solenoid 106 protrudes to a position located at the left of the solenoid bobbin 142 in FIG. 2, and the spacer 146 is fitted on an outer circumferential surface of a left end of the second fixed iron core 152. Specifically, the spacer 146 has a cylindrical shape and includes an inner flange 176 at an inner circumferential surface of a right end of the spacer 146, and an outer circumferential surface of the second fixed iron core 152 is fitted on an inner circumferential surface of the inner flange 176. The spacer 146 is also fitted in the inner circumferential surface of the pipe 130 provided on the outer tube 38, and an area between the spacer 146 and the pipe 130 is sealed off by a seal ring 178 mounted on an outer circumferential surface of the spacer 146.

The fail-safe valve 112 includes: the fail-safe member 158 slidably mounted on the outer circumferential surface of the large outside diameter portion 126 of the valve housing 102; and a spring 180 as a compression coil spring which is provided between the fail-safe member 158 and the inner flange 176 of the spacer 146 and thereby serves as an fail-safe elastic member. It is noted that the fail-safe valve 112 works when no electric power is supplied to the damping force generator 12, in other words, when the coil 140 of the solenoid 106 is not energized. For example, the fail-safe valve 112 works in the event of electrical failure in the absorber. That is, the fail-safe valve 112 is named based on this function.

The fail-safe member 158 has a generally cylindrical shape and includes: a flange 182 provided on its outer circumferential portion; an annular protrusion 184 facing a right end face of the flange 124 of the valve housing 102 in FIG. 2; an orifice 186 communicating with an inner circumferential surface and an outer circumferential surface of the fail-safe member 158; and a communication hole 188 opening from a right end of the fail-safe member 158 in FIG. 2 and extending to the orifice 186. The fail-safe member 158 is always urged toward the flange 124 of the valve housing 102 by the spring 180 provided between the flange 182 and the inner flange 176 of the spacer 146.

The right end of the fail-safe member 158 faces the left end of the second fixed iron core 152, and as illustrated in FIG. 3, the magnetic path is formed so as to pass through the second fixed iron core 152, the fail-safe member 158, the valve housing 102, the pipe 130, and the casing 134. In view of the above, when the coil 140 is excited in the solenoid 106, the fail-safe member 158 is pulled by the second fixed iron core 152, and an urging force is applied to the fail-safe member 158 in the right direction in FIG. 2. When the magnitude of the current supplied to the solenoid 106 becomes greater than or equal to the threshold value, the urging force applied to the fail-safe member 158 by the solenoid 106 overcomes the urging force applied by the spring 180, so that the fail-safe member 158 is pulled to the second fixed iron core 152. As a result, the fluid passage 100 is opened in its maximum degree.

When the current supplied to the solenoid 106 does not become greater than the threshold value, on the other hand, the urging force applied to the fail-safe member 158 by the solenoid 106 cannot overcome the urging force applied by the spring 180, so that the fail-safe member 158 is located at a position at which the annular protrusion 184 is held in contact with the flange 124 of the valve housing 102. As a result, the fluid passage area is limited. Specifically, since the orifice 186 of the fail-safe member 158 faces the fluid passage 100 at the time, and the fluid passage 100 is fluidically coupled only via the orifice 186, the fluid passage area is limited to the fluid passage area of the orifice 186.

In other words, when the current supplied to the solenoid 106 becomes greater than or equal to the threshold value, the fail-safe valve 112 is positioned at an open position for opening the fluid passage 100, and when the current supplied to the solenoid 106 is less than the threshold value, on the other hand, the fail-safe valve 112 is positioned at a fail-safe position at which the fluid passage 100 is fluidically coupled only via the orifice 186.

It is noted that even when the fail-safe member 158 is held in close contact with the second fixed iron core 152, the communication hole 188 is not closed by the end portion of the second fixed iron core 152 so as to be kept in its communicating state, and accordingly a space for accommodating the movable iron core 156 is not closed even in the state in which the fail-safe member 158 is held in close contact with the second fixed iron core 152. This construction prevents an occurrence of a situation in which the valve member 104 is locked and cannot be moved.

[C] Damping Force generated by Damping Force Generator

As understood from the above-described constructions and operations, when no current is supplied to the solenoid 106 in the damping force generator 12, that is, when no current is supplied to the damping force generator 12, it is possible to consider that a fluid passage (an auxiliary fluid passage) is formed which includes the fluid passage 100 and a fluid passage that allows communication of the fluid passage 100 only via the orifice 186. The damping force generator 12 is configured such that a resistance is provided to a flow of the working fluid passing through the auxiliary fluid passage to provide a resistance to a flow of the working fluid passing through the damping force generator 12. As a result, the damping force generator 12 is configured such that when no current is supplied to the damping force generator 12, the damping force generator 12 generates a current-non-supply-state set damping force as a damping force having a preset magnitude, specifically, the damping force generator 12 generates the current-non-supply-state set damping force for the extension and compression of the cylinder 10. It is noted that, as will be explained later in detail, the magnitude of the damping force is determined by the inside diameter (the diameter of the fluid passage) of the orifice 186, and a damping coefficient based on which the damping force is determined (a current-non-supply-state set damping coefficient) is generally fixed in broad sense.

When the current having a magnitude greater than or equal to the threshold value is supplied to the solenoid 106 in the damping force generator 12, that is, when the current having a magnitude greater than or equal to the threshold value is supplied to the damping force generator 12, it is possible to consider that a fluid passage (a main fluid passage) is formed which includes a fluid passage allowing communication of the fluid passage 100 via an area between the flange 124 of the valve housing 102 and the annular protrusion 184 of the fail-safe member 158. The damping force generator 12 is configured such that a resistance is provided to a flow of the working fluid passing through the main fluid passage to provide a resistance to a flow of the working fluid passing through the damping force generator 12. Specifically, the valve mechanism 98 is provided in the fluid passage 100, and a resistance is provided to a flow of the working fluid passing through an area between the valve seat 122 and the valve member 104 constituting the valve mechanism 98. The magnitude of this resistance depends on the size of the space between the valve seat 122 and the valve member 104, i.e., a degree of opening of the valve mechanism 98. The urging force applied to the valve member 104 by the solenoid 106 depends on the magnitude of the current supplied to the solenoid 106. Thus, the degree of opening of the valve mechanism 98 decreases with increase in the current due to the construction of the valve mechanism 98. That is, it becomes more difficult for the valve mechanism 98 to be opened. Accordingly, the resistance provided to the flow of the working fluid passing through the main fluid passage increases with increase in the supplied current. In view of the above, the damping force generator 12 is configured such that, when the current having the magnitude greater than or equal to the threshold value is supplied to the damping force generator 12, the damping force generator 12 generates a current-dependent damping force as a damping force having a magnitude related to the magnitude of the current, specifically, the damping force generator 12 generates the current-dependent damping force for the extension and compression of the cylinder 10. The current-dependent damping force increases with increase in the supplied current, and a damping coefficient based on which the damping force is determined (a current-dependent damping coefficient) increases with increase in the current. That is, the damping force generator 12 is configured to generate the current-dependent damping force of the magnitude related to the magnitude of the current by changing the resistance provided to the flow of the working fluid passing through the main fluid passage depending on the magnitude of the current supplied to the damping force generator 12.

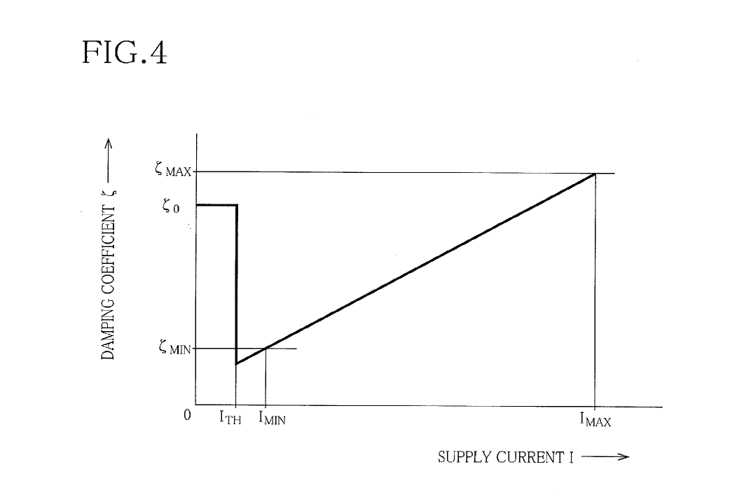

There will be explained the current-non-supply-state set damping force and the current-dependent damping force in detail. In the damping force generator 12, a damping coefficient based on which a damping force F_{D} generated by the damping force generator 12 is determined changes depending on a magnitude of a supplied current I as illustrated in the schematic graph in FIG. 4. Specifically, the damping coefficient ζ is a current-non-supply-state set damping coefficient ζ₀ until the supply current I exceeds a required current value I_{TH}, and the damping coefficient becomes a current-dependent damping coefficient ζ_{A} when the supply current I becomes greater than or equal to the required current value I_{TH} and increases with increase in the supply current I.

The absorber according to the present embodiment is configured such that the current I in a set range is supplied to the damping force generator 12 in a normal state to generate a current-dependent damping force F_{DA}. Specifically, the damping force generator 12 receives a current I_{A} between a lower limit current I_{MIN} and an upper limit current I_{MAX} each as a set value. Accordingly, in the case where a damping coefficient ζ_{A} when the lower limit current I_{MIN} is supplied is referred to as “lower limit damping coefficient I_{MIN}”, and the damping coefficient when the upper limit current I_{MAX} is supplied is referred to as “upper limit damping coefficient ζ_{MAX}”, the current-dependent damping coefficient ζ_{A} is changed between the lower limit damping coefficient ζ_{MIN} and the upper limit damping coefficient ζ_{MAX}, and the damping force generator 12 generates the damping force F_{DA} within a range related to change in the current-dependent damping coefficient that is, the damping force generator 12 generates the damping force F_{DA} between a minimum damping force F_{MIN} that is the smallest current-dependent damping force F_{DA} established when the current-dependent damping coefficient ζ_{A} is the lower limit damping coefficient ζ_{MIN} and a maximum damping force F_{MAX} that is the largest current-dependent damping force F_{DA} established when the current-dependent damping coefficient ζ_{A} is the upper limit damping coefficient ζ_{MAX}.

It is noted that the damping force generator 12 is configured such that the lower limit current I_{MIN} is set to be slightly greater than the required current value I_{TH}. That is, a certain degree of margin is provided for the lower limit current I_{MIN} with respect to the required current value I_{TH}. For example, there are possibilities of fluctuations and shortages of the current supplied to the solenoid 106 due to instability of the voltage of the battery 92, and a switch of the fail-safe valve 112 to the fail-safe position is expected to rapidly change the damping coefficient ζ in the case where a current I having a magnitude that is close to that of the lower limit current I_{MIN}. In view of this situation, the margin is provided.

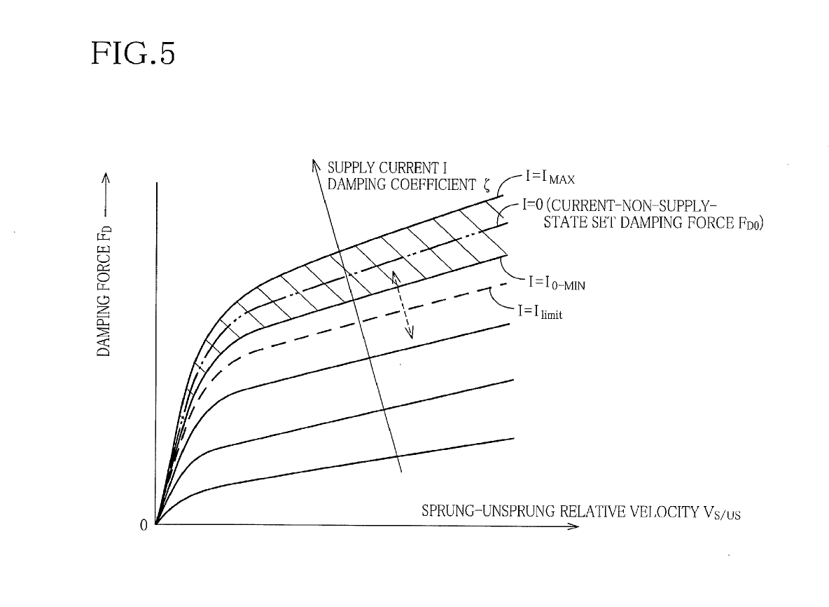

As illustrated in FIG. 4, the current-non-supply-state set damping coefficient ζ_{A} is set to be less than the upper limit damping coefficient ζ_{MAX}. That is, a current-non-supply-state set damping force F_{D0} is set to be less than a maximum damping force F_{DA-MAX} determined based on the upper limit damping coefficient ζ_{MAX}. A damping force to be actually generated by the damping force generator 12 when no current is supplied to the damping force generator 12 may vary, for example, the damping force may be larger than or smaller than the current-non-supply-state set damping force F_{D0}. It is noted that the graph in FIG. 5 schematically illustrates the damping force F_{D} with respect to a sprung-unsprung relative velocity v_{S/US}, and the damping force may vary within a range hatched in this figure. The current-non-supply-state set damping force F_{D0}, i.e., the current-non-supply-state set damping coefficient ζ_{A} is set such that the maximum value of the range within which the damping force may vary is equal to the maximum damping force F_{MAX}. Specifically, the damping force generator 12 is configured such that the diameter of the orifice 186 is adjusted so as to obtain the current-non-supply-state set damping coefficient described above.

### [D] Control of Shock Absorber

i) Control in Normal Situations

Control of the shock absorber in a normal state is executed by controlling the current supplied to the damping force generator 12 for the primary purpose of restraining vibrations of the sprung portion of the vehicle. The absorber according to the present embodiment utilizes the above-described construction to generate the damping force for relative movement between the sprung portion and the unsprung portion. Thus, in the case where the damping coefficient of the absorber is constant, the absorber cannot generate an effective damping force for motions of the sprung portion. To generate a damping force appropriate for restraining vibrations of the sprung portion, the current supplied to the damping force generator 12 is controlled based on a velocity of movement of the sprung portion in the up and down direction (hereinafter may be referred to as “sprung-portion absolute velocity”.

Specifically, assuming that the damping force appropriate for restraining the vibrations of the sprung portion is a theoretical damping force F_{DS}, the theoretical damping force F_{DS} can be broadly expressed in the following equation:

F_{DS}=ζ_{S}·v_{S}

It is noted that v_{S} is the sprung-portion absolute velocity, and ζ_{S} is a theoretical damping coefficient (which can be considered to be a positive constant value) for generating the theoretical damping force F_{DS}. It is noted that the sprung-portion absolute velocity v_{S} takes a positive value while the sprung portion is being moved upward, and takes a negative value while the sprung portion is being moved downward. In response, the theoretical damping force F_{DS} takes a positive value in the case where the theoretical damping force F_{DS} serves as a force for urging the sprung portion downward, that is, in the case where the theoretical damping force F_{DS} serves as a resistance to upward movement of the sprung portion, and the theoretical damping force F_{DS} takes a negative value in the case where the theoretical damping force F_{DS} serves as a force for urging the sprung portion upward, that is, in the case where the theoretical damping force F_{DS} serves as a force for propelling upward movement of the sprung portion.

The damping force F_{D} to be actually generated by the absorber has a magnitude related to the sprung-unsprung relative velocity v_{S/US} based on the damping coefficient ζ of the absorber as expressed in the following equation:

F_{D}=ζ·v_{S/US}

It is noted that the sprung-unsprung relative velocity v_{S/US} takes a positive value in the case where the sprung portion and the unsprung portion are moved away from each other, i.e., in the rebound motion, and the sprung-unsprung relative velocity v_{S/US} takes a negative value in the case where the sprung portion and the unsprung portion are moved toward each other, i.e., in the bound motion. In response, the damping force F_{D} takes a positive value in the case where the damping force F_{D} serves as a force for urging the sprung portion and the unsprung portion toward each other, i.e., in the case where the damping force F_{D} serves as a resistance to movement of the sprung portion and the unsprung portion away from each other, and the damping force F_{D} takes a negative value in the case where the damping force F_{D} serves as a force for urging the sprung portion and the unsprung portion away from each other, i.e., in the case where the damping force F_{D} serves as a resistance to movement of the sprung portion and the unsprung portion toward each other.

Accordingly, a required damping coefficient as a damping coefficient ζ to be required is determined according to the following equation based on the above-described two equations such that the damping force F_{D} to be actually generated by the absorber is equal to the theoretical damping force F_{DS}, and then the current to be supplied to the damping force generator 12 is controlled so as to obtain the determined damping coefficient ζ. This process can generate the damping force F_{D} effective to restrain the vibrations of the sprung portion.

ζ_{R}=ζ_{S}·(v_{S}/v_{S/US})

In the damping force generator 12, the current I to be supplied is controlled between the lower limit current I_{MIN} and the upper limit current I_{MAX} so as to achieve the required damping coefficient ζ_{R} determined according to the above-described equation.

However, in the case where signs of the sprung-portion absolute velocity and the sprung-unsprung relative velocity are different from each other, the required damping coefficient takes a negative value, so that the absorber needs to generate a negative damping force F_{D}, i.e., propelling power. Specifically, displacement between vibrations of the sprung portion and vibrations of the sprung portion and the unsprung portion (phase displacement) may establish a case where the bound motion is caused although the sprung portion is moved upward or a case where the rebound motion is caused although the sprung portion is moved downward, for example. In these cases, motions of the sprung portion and the unsprung portion at the time need to be propelled. However, the absorber according to the present embodiment cannot generate the above-described propelling power and desirably reduces the damping force F_{D} generated by the absorber as small as possible. That is, the current I to be supplied is controlled to the lower limit current I_{MIN} in this case such that the damping coefficient ζ of the absorber is made as small as possible, specifically, the damping coefficient ζ of the absorber becomes the lower limit damping coefficient ζ_{MIN}.

ii) Reduction in Power Consumption

The present shock absorber is configured to reduce power consumption of the damping force generator 12. Specifically, when the supply current I supplied to the damping force generator 12 exceeds the threshold value, the control in normal situations is discontinued to inhibit the supply of the current to the damping force generator 12. That is, when the supply current I supplied to the damping force generator 12 exceeds the threshold value, the damping force generator 12 generates the current-non-supply-state set damping force F_{D0}.

Specifically, the controller 90 uses the thermometer 94 to always monitor the temperature T of the controller 90 and based on the temperature T determines a limit value Iₗᵢₘᵢₜ of the current supplied to the damping force generator 12. The controller 90 uses the determined limit value Iₗᵢₘᵢₜ as the above-described threshold value and inhibits the supply of the current to the damping force generator 12 when the supply current I supplied to the damping force generator 12 exceeds the limit value Iₗᵢₘᵢₜ. It is noted that when the limit value Iₗᵢₘᵢₜ is greater than or equal to the upper limit current I_{MAX}, the control in normal situations is executed.

The controller 90 receives the remaining power amount Q of the battery 92 therefrom. When the remaining power amount Q is lower than a threshold remaining amount Q_{TH} as a threshold value of the remaining power amount Q, the controller 90 further reduces power consumption. Specifically, when a damping force in a range within which the damping force may vary in the case where the supply of the current is inhibited (the hatched range in FIG. 5) is to be generated as the current-dependent damping force F_{DA}, the control in normal situations is discontinued to inhibit the supply of the current to the damping force generator 12. Concretely, assuming that a minimum-set-damping-force-corresponding current value I_{O-MIN} is a value of a current having a magnitude which generates, as the current-dependent damping force, a damping force having a magnitude equal to a minimum value of a range of possible variation of the damping force, when the remaining power amount Q becomes smaller than the threshold remaining amount Q_{TH}, and the limit value Iₗᵢₘᵢₜ determined as described above exceeds the minimum-set-damping-force-corresponding current value I_{O-MIN}, the minimum-set-damping-force-corresponding current value I_{O-MIN} is used as the threshold value.

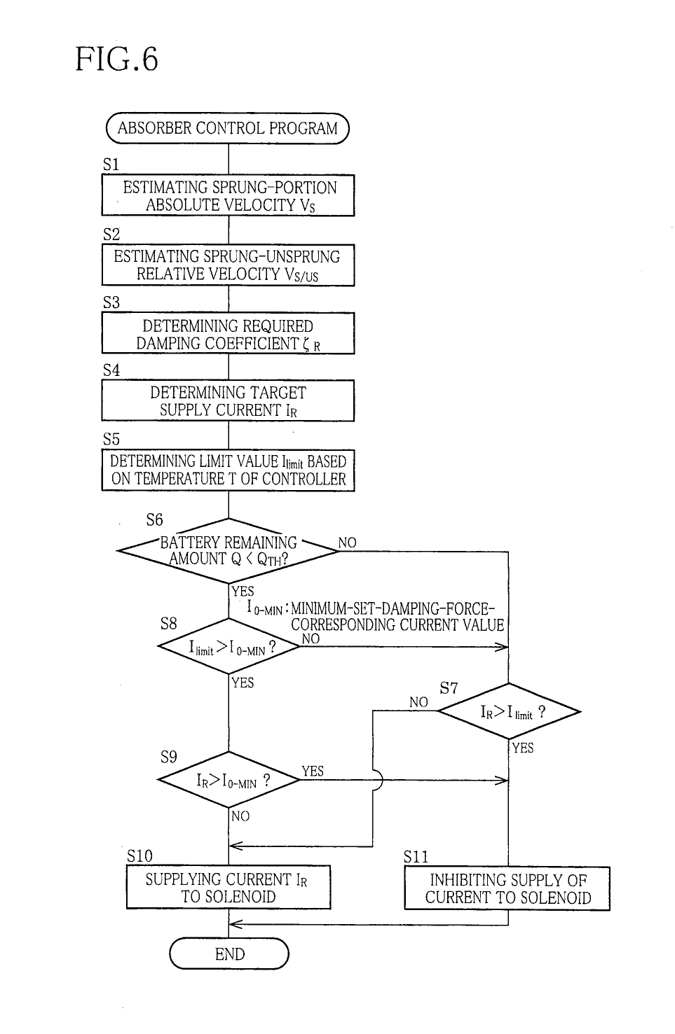

The above-described control of the absorber according to the present embodiment is executed by the controller 90 constituted mainly by a computer, according to an absorber control program illustrated in a flow chart in FIG. 6. It is noted that this program is repeatedly executed at short intervals (e.g., time intervals ranging from several microseconds to several tens of microseconds). There will be next explained the above-described control specifically with reference to the flow chart.

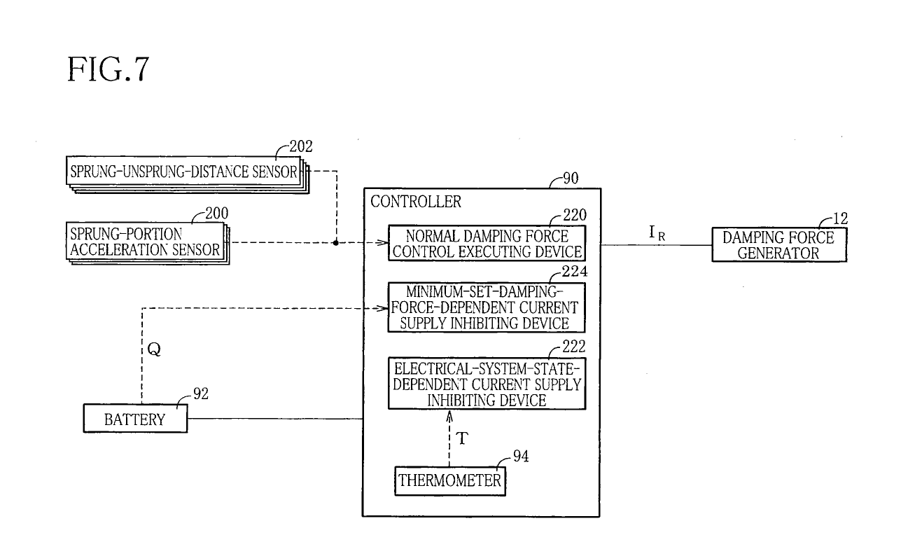

According to the above-described program, the sprung-portion absolute velocity v_{S} is first estimated at Step 1 (hereinafter Step is referred to as “S”). The vehicle equipped with the present absorber is provided with a sprung-portion acceleration sensor 200 (see FIG. 7) configured to detect sprung acceleration as acceleration of the sprung portion in the up and down direction. The sprung-portion absolute velocity v_{S} is estimated based on a detection value of the sensor at the preceding or previous execution of the program and a detection value of the sensor at the current execution. The sprung-unsprung relative velocity v_{S/US} is estimated at S2. The vehicle equipped with the present absorber is provided with a sprung-unsprung-distance sensor 202 configured to detect a distance between the sprung portion and the unsprung portion. The sprung-unsprung relative velocity v_{S/US} is estimated based on a detection value of the sensor at the preceding or previous execution of the program and a detection value of the sensor at the current execution. The required damping coefficient ζ_{R} is determined at S3 according to the above-described equation (ζ_{R}=(v_{S}/v_{S/US})) based on the estimated sprung-portion absolute velocity v_{S} and sprung-unsprung relative velocity v_{S/US}. The supply current I_{R} to be supplied to the damping force generator 12 is at S4 determined based on the required damping coefficient. It is noted that the controller 90 stores a map as indicated by the graph in FIG. 4, and the target supply current I_{R} is determined with reference to the map.

At S5-S9, it is determined whether the supply of the current to the damping force generator 12 is to be inhibited or not. At S5, the limit value Iₗᵢₘᵢₜ for limiting the current to be supplied to the damping force generator 12 is determined based on the temperature T of the controller 90 which is detected by the thermometer 94. It is determined at S6 whether the remaining power amount Q of the battery 92 is smaller than a threshold value Q_{TH} or not. When the remaining power amount Q is larger than the threshold value Q_{TH}, the limit value Iₗᵢₘᵢₜ is at S7 used as the threshold value, and it is determined whether the target supply current I_{R} is greater than the limit value Iₗᵢₘᵢₜ or not.

When the remaining power amount Q is smaller than the threshold value Q_{TH}, it is determined at S8 whether the limit value Iₗᵢₘᵢₜ is larger than the minimum-set-damping-force-corresponding current value I_{O-MIN} or not. When the limit value Iₗᵢₘᵢₜ is larger than the minimum-set-damping-force-corresponding current value I_{O-MIN}, the minimum-set-damping-force-corresponding current value I_{O-MIN} is used at S9 as the threshold value, and it is determined whether the target supply current I_{R} is greater than the minimum-set-damping-force-corresponding current value I_{O-MIN} or not. When the limit value Iₗᵢₘᵢₜ is smaller than or equal to the minimum-set-damping-force-corresponding current value I_{O-MIN}, it is determined at S7 whether the target supply current I_{R} is greater than the limit value Iₗᵢₘᵢₜ or not.

When the target supply current I_{R} is less than or equal to the threshold value at S7 or S9, the current I_{R} is supplied to the damping force generator 12, specifically, the solenoid 106, to execute the control in normal situations. When the target supply current I_{R} is greater than the threshold value at S7 or S9, the supply of the current to the solenoid 106 is inhibited, and the current-non-supply-state set damping force F_{D0} is generated by the damping force generator 12. Thus, one cycle of execution of the absorber control program is terminated.

### [E] Functional Configuration of Controller

FIG. 7 is a functional block diagram schematically illustrating functions of the controller 90. Based on the functions, the controller 90 includes a functional portion configured to execute the control in normal situations, namely, a normal damping force control executing device 220 as a functional portion configured to control the current supplied to the damping force generator 12 to cause the damping force generator 12 to generate the current-dependent damping force. The controller 90 further includes current supply inhibiting devices 222, 224. Specifically, the controller 90 includes (I) the electrical-system-state-dependent current supply inhibiting device 222 configured to determine a threshold value based on a state of an electrical system relating to the hydraulic shock absorber and inhibit the supply of the current to the damping force generator 12 when the current to be supplied to the damping force generator 12 is greater than the determined threshold value and (II) the minimum-set-damping-force-dependent current supply inhibiting device 224 configured to: use, as the threshold value, the minimum-set-damping-force-corresponding current value that is a value of a current having a magnitude which is to generate, as the current-dependent damping force, a damping force having a magnitude equal to the minimum value of the range of possible variation of the damping force when no current is supplied to the damping force generator 12; and inhibit the supply of the current to the damping force generator 12 when the current to be supplied to the damping force generator 12 is greater than the minimum-set-damping-force-corresponding current value.

In the controller 90 of the present shock absorber, the normal damping force control executing device 220 includes a portion configured to execute the processings S1-S4 and S10 in the absorber control program, the electrical-system-state-dependent current supply inhibiting device 222 includes a portion configured to execute the processings S5, S9, and S11 in the program, and the minimum-set-damping-force-dependent current supply inhibiting device 224 includes a portion configured to execute the processings S6, S8, S9, and S11 in the program.

The hydraulic shock absorber according to the present embodiment configured as described above can reduce power consumed by the damping force generator 12. Also, even when the supply of the current to the damping force generator 12 is inhibited, the damping force generator 12 generates the current-non-supply-state set damping force as a generally fixed damping force, thereby reliably achieving a damping capacity. It is noted that the present hydraulic shock absorber is configured such that a damping force within a range of the damping force which may be actually generated by the damping force generator 12 with respect to the current-non-supply-state set damping force is within a range of the current-dependent damping force. Thus, when no current is supplied to the damping force generator 12, the damping force generator 12 does not generate a larger damping force than necessary. Accordingly, even when no current is supplied to the damping force generator 12, effective vibration damping is possible.

### EXPLANATION OF REFERENCE NUMERALS

10: Cylinder, 12: Damping Force Generator, 20: Housing, 22: Piston, 24: Rod, 30: Rod-side Chamber, 32: Opposite-rod-side Chamber, 40: Buffer Chamber, 90: Controller, 92: Battery (Power Source), 94: Thermometer, 98: Valve Mechanism, 100: Fluid Passage (Main Fluid Passage, Auxiliary Fluid Passage), 106: Solenoid, 112: Fail-safe Valve, 186: Orifice (Auxiliary Fluid Passage), 220: Normal Damping Force Control Executing Device, 222: Electrical-system-state-dependent Current Supply Inhibiting Device, 224: Minimum-set-damping-force-dependent Current Supply Inhibiting Device

F_{DA}: Current-dependent Damping Force, F₀: Current-non-supply-state Set Damping Force, I_{R}: Target Damping Coefficient, Iₗᵢₘᵢₜ: Limit Value (Threshold Value), I_{O-MIN}: Minimum-set-damping-force-corresponding Current Value (Threshold Value), T: Temperature of Controller, Q: Remaining Power Amount, Q_{TH}: Threshold Remaining Amount

1. A hydraulic shock absorber, comprising:
a cylinder comprising: a housing configured to store working fluid; a piston provided slidably in the housing; and a rod comprising one end portion coupled to the piston and another end portion protruding from the housing, the cylinder being provided so as to connect between a sprung portion and an unsprung portion of a vehicle, the cylinder being extended and compressed by relative movement between the sprung portion and the unsprung portion;
a damping force generator configured to provide a resistance to a flow of the working fluid with at least one of extension and compression of the cylinder to generate a damping force for the at least one of the extension and the compression of the cylinder, the damping force generator being configured to, when a current is supplied to the damping force generator, generate a current-dependent damping force as a damping force having a magnitude related to a magnitude of the supplied current, the damping force generator being configured to, when no current is supplied to the damping force generator, generate a current-non-supply-state set damping force as a damping force having a preset magnitude; and
a controller configured to supply the current to the damping force generator and control a magnitude of the supplied current,
the controller being configured to, when the current to be supplied to the damping force generator is greater than a threshold value, inhibit a supply of the current to the damping force generator,
the controller comprising an electrical-system-state-dependent current supply inhibiting device configured to determine the threshold value based on a state of an electrical system relating to the hydraulic shock absorber and to, when the current to be supplied to the damping force generator is greater than the determined threshold value, inhibit the supply of the current to the damping force generator,
the electrical-system-state-dependent current supply inhibiting device using a temperature of the controller as the state of the electrical system relating to the hydraulic shock absorber.

2. The hydraulic shock absorber according to claim 1, wherein the damping force generator is configured such that the current-dependent damping force generated by the damping force generator increases with increase in current supplied to the damping force generator.

3. The hydraulic shock absorber according to claim 2, wherein the hydraulic shock absorber is configured such that a magnitude of the current-non-supply-state set damping force is less than an upper limit value of the current-dependent damping force.

4. The hydraulic shock absorber according to claim 2,
wherein the hydraulic shock absorber is configured such that when no current is supplied to the damping force generator, there are variations in the damping force to be actually generated by the damping force generator, and
wherein a magnitude of the current-non-supply-state set damping force is set such that a maximum value of a range of possible variation of the damping force when no current is supplied to the damping force generator is equal to an upper limit value of the current-dependent damping force.

5. (canceled)

6. (canceled)

7. The hydraulic shock absorber according to claim 1,
wherein the hydraulic shock absorber is configured such that when no current is supplied to the damping force generator, there are variations in the damping force to be actually generated by the damping force generator,
wherein the damping force generator is configured such that the current-dependent damping force generated by the damping force generator increases with increase in current supplied to the damping force generator, and
wherein the controller includes a minimum-set-damping-force-dependent current supply inhibiting device configured to: use, as the threshold value, a minimum-set-damping-force-corresponding current value which is a value of the current having a magnitude which is to generate, as the current-dependent damping force, the damping force having a magnitude equal to a minimum value of a range of possible variation of the damping force when no current is supplied to the damping force generator; and inhibit the supply of the current to the damping force generator when the current to be supplied to the damping force generator is greater than the minimum-set-damping-force-corresponding current value.

8. The hydraulic shock absorber according to claim 1,
wherein the damping force generator comprises: a main fluid passage through which the working fluid passes when the current is supplied to the damping force generator; and an auxiliary fluid passage through which the working fluid passes when no current is supplied to the damping force generator, and
wherein the damping force generator configured to: change the resistance to the flow of the working fluid passing through the main fluid passage in accordance with a magnitude of the current supplied to the damping force generator, to generate the current-dependent damping force having the magnitude related to the magnitude of the current; and provide the resistance to the flow of the working fluid passing through the auxiliary fluid passage, to generate the current-non-supply-state set damping force.
